(19) United States
(12) Patent Application Publication
(10) Pub. No.: US 2013/0249209 A1
(43) Pub. Date: Sep. 26, 2013

(54) PLUG-IN CONNECTION ARRANGEMENT

(71) Applicant: VERITAS AG, Gelnhausen (DE)

(72) Inventors: Heribert NETZER, HANAU (DE); Alexander EMMERLING, BAD VILBEL (DE)

(21) Appl. No.: 13/848,910

(22) Filed: Mar. 22, 2013

(30) Foreign Application Priority Data
Mar. 26, 2012 (DE) 10 2012 005 930.2

(51) Int. Cl. F16L 25/00

(52) U.S. Cl. CPC F16L 25/009
USPC 285/81

(57) ABSTRACT

A plug-in connection arrangement for releasably connecting fluid lines is presented. The plug-in connection arrangement comprises a basic body which has a supply line and an insertion opening, wherein the basic body is connectable to one of the fluid lines, and wherein a connecting piece, which is connectable to a second of the fluid lines, can be plugged onto the supply line in order to form a tight connection with the supply line, having a fixing element which is accommodated in the insertion opening and is fixed in the insertion opening in the axial direction of the supply line in order to secure the connecting piece in a fitting position, and having a connection element which is mounted on the supply line so as to be movable in the axial direction and prestresses the fixing element in the radial direction in an axial position.

### CROSS-REFERENCE TO RELATED APPLICATIONS

This application claims the priority of German patent application DE 10 2012 005 930.2, filed Mar. 26, 2012. The entire content of this priority application is incorporated herein by reference.

### BACKGROUND OF THE INVENTION

The present invention relates to a plug-in connection arrangement for releasably connecting fluid lines, said plug-in connection arrangement comprising a basic body which has a supply line and an insertion opening, wherein the basic body is connectable to one of the fluid lines, and wherein a connecting piece which is connectable to a second of the fluid lines, can be plugged onto the supply line in order to form a tight connection with the supply line, and having a fixing element which is accommodated in the insertion opening and is fixed in the insertion opening in the axial direction of the supply line in order to secure the connecting piece in a fitting position.

From the prior art, in particular from the field of combustion engine engineering, it is known to connect fluid lines together by means of plug-in connections for pumping media, in particular fuel. In this case, it is of particular interest that the fluid lines form a tight connection which can be loaded by an internal pressure. In addition, it is important that the plug-in connections are realized in a universal manner, that is that the plug-in connection is able to be connected to several lines in order to reduce the number of different components.

In the case of plug-in connections in the field of automobiles, it is particularly important that the plug-in connections form a reliable and long-lived connection and at the same time are able to be released in a non-destructive manner in the event of repair. In addition, it is of interest that the plug-in connections are mountable in a simple and rapid manner in order to reduce the production costs of the entire assembled unit in this manner. Usually, these types of plug-in connections are realized by means of two pipe portions which can be connected one on top of the other and are fixed to each other by means of a screw or clamping connection. In this case, the pipe portions are first of all slipped one on top of the other and are moved into a final fitting position. Once the final fitting position has been reached, a clamping or screw connection element is attached to the pipe portions which are slipped one on top of another in order to connect the pipe portions in a fixed manner.

A disadvantage, in this case, is that these types of plug-in connections are generally technically expensive, have to be assembled taking up a large effort of time and money and the correct assembly has to be checked with a large effort of time and money.

### BRIEF SUMMARY OF THE INVENTION

It is an object of the present invention to provide a plug-in connection arrangement for the releasable connection of fluid lines, which forms a reliable connection between the fluid lines and at the same time being able to be mounted costing a small amount of time and money and being able to be checked costing a small amount of time and money.

According to a first aspect of the invention a plug-in connection arrangement is provided for releasably connecting fluid lines, comprising a basic body which has a supply line and a insertion opening, wherein the basic body is connectable to one of the fluid lines, and wherein a connecting piece, which is connectable to a second of the fluid lines, can be plugged onto the supply line in order to form a tight connection with the supply line, a fixing element which is accommodated in the insertion opening and is fixed in the insertion opening in the axial direction of the supply line in order to secure the connecting piece in a fitting position, and a connection element which is mounted on the supply line so as to be movable in the axial direction and prestresses the fixing element in the radial direction in an axial position.

According to a second aspect of the invention a plug-in connection arrangement is provided for releasably connecting fluid lines, comprising a basic body which has a supply line and a insertion opening, wherein the basic body is connectable to one of the fluid lines, and wherein a connecting piece, which is connectable to a second of the fluid lines, can be plugged onto the supply line in order to form a tight connection with the supply line, a fixing element which is accommodated in the insertion opening and is fixed in the insertion opening in the axial direction of the supply line in order to secure the connecting piece in a fitting position, wherein the basic body has an accommodating portion which is formed between an axial stop of the basic body and the insertion opening, wherein a connection element is insertable into the accommodating portion by means of the connecting piece, and wherein the connection element in the accommodating portion is compressed in such a manner that the connecting piece is fixed coaxially with respect to the supply line.

According to a third aspect of the invention a plug-in connection arrangement is provided comprising a basic body which has a supply line and a insertion opening, wherein the basic body is connectable to one of the fluid lines, and wherein a connecting piece, which is connectable to a second of the fluid lines, can be plugged onto the supply line in order to form a tight connection with the supply line, a fixing element which is accommodated in the insertion opening and is fixed in the insertion opening in the axial direction of the supply line in order to secure the connecting piece in a fitting position, and a connection element which is mounted on the supply line so as to be movable in the axial direction, wherein the connection element is movable in a fitting position by means of the connecting piece, wherein the connection element has an extension which protrudes in the axial direction and projects into an opening of the basic body in the fitting position in order to indicate the position of the connection element.

According to a fourth aspect of the invention a plug-in connection arrangement is provided for releasably connecting fluid lines, comprising a basic body which has a supply line and a insertion opening, wherein the basic body is connectable to one of the fluid lines, and wherein a connecting piece, which is formed as a connection tube is connectable to a second of the fluid lines, can be plugged onto the supply line in order to form a tight connection with the supply line, a fixing element which is accommodated in the insertion opening and is fixed in the insertion opening in the axial direction of the supply line in order to secure the connecting piece in a fitting position, and a connection element which is mounted on the supply line so as to be movable in the axial direction between a first and a second axial position, wherein the fixing element abuts against the connection element in the first axial position and wherein the connection element prestresses the fixing element in the radial direction in the first axial position, and wherein the connection element is movable into a second axial position by means of the connecting piece such that the fixing element is released from the connection element, and abuts against the connecting piece in order to secure the connecting piece in the axial direction in the fitting position.

By, according to the first aspect of the present invention, providing a connection element which is mounted on the supply line so as to be movable in the axial direction and prestresses the fixing element in the radial direction in an axial position, the connecting piece can be connected to the supply line through simple sliding onto the supply line. As the connection element already prestresses the fixing element in the radial direction, the connection element can be slid further onto the supply line without the radial prestressing force having to be applied during the sliding-on movement. As a result, the time and money spent on assembly can be reduced as the subsequent assembly step of the fixing element is omitted and at the same time the force for sliding on the connecting piece is reduced.

By, according to the second aspect of the present invention, the connection element being compressed in the accommodating portion and the connecting piece being fixed coaxially with respect to the supply line, simply by sliding the connecting piece onto the supply line the connecting piece can be centered and fixed, as a result of which the time and money spent on assembly is reduced and at the same time the connecting piece can be mounted on the supply line in an optimum position.

By, according to the third aspect of the present invention, providing a connection element which is provided on the supply line so as to be movable in the axial direction, and which is movable into the fitting position by means of the connecting piece and at the same time has a protruding extension which projects into an opening of the basic body in the fitting position, the position of the connection element can be indicated. In this case, the protruding extension at the same time indicates whether a connection element is mounted and whether the connecting piece has been moved into the final assembly position. As a result, using simple technical means it is possible to check whether the connecting piece has been moved into the final assembly position, as a result of which the assembly becomes generally more reliable.

In a particular embodiment of the first aspect of the present invention, the connection element is movable into a second axial position by means of the connecting piece such that the fixing element abuts against the connecting piece and secures the connecting piece in the axial direction.

This means that the connecting piece can be fixed simply by plugging onto the supply line, as a result of which the subsequent assembly step for the fixing element is omitted and the effort of time and money spent on the connecting piece is reduced.

In this case, it is particularly preferred when the basic body has an axial stop for the connecting piece, and wherein the connection element in the second axial position is arranged between the axial stop and the insertion opening.

This means that a fitting position of the connecting piece can be defined and the fixing element can be moved to abut against the connecting piece in a reliable manner such that a reliable and fixed fitting position is achieved.

In the case of the second aspect of the present invention, it is particularly preferred when the connection element has a centering portion with an outer radius which is greater than an inner radius of the accommodating portion.

This ensures that the connection element is not moved unintentionally or incorrectly into the fitting position as a defined force has to be exerted in the axial direction by the connecting piece in order to move the connection element into the accommodating portion.

In this case, it is particularly preferred when the accommodating portion is formed coaxially with respect to the supply line.

This means that simply by inserting the connection element, the connecting piece can be fixed and centered coaxially with respect to the supply line.

In the case of the third aspect of the present invention, it is particularly preferred when the connection element is arranged between an axial stop of the basic body and the insertion opening in the fitting position.

This means that a fitting position of the connection element is defined in relation to the basic body, as a result of which the fitting position of the connection element and of the connecting piece can be indicated in a reliable manner.

It is generally preferred when the connection element has a stop element which forms with the basic body a second axial stop for the connection element, and wherein an idle path is formed between the first axial stop and the second axial stop.

This means that the connection element can be pre-mounted in a captive manner on the basic body.

In this case, it is particularly preferred when the connection element is mounted on the supply line between the first and the second axial stop so as to be movable in the axial direction.

This means that the connection element can be moved back and forth in an arbitrary manner between the two axial positions during assembly and during disassembly, as a result of which assembly and non-destructive disassembly is generally simplified.

It is additionally preferred when a fitting position is formed on the first axial stop and a pre-assembly position is formed on the second axial stop.

Through said definition of the fitting position and of the pre-assembly position, the mounting of the fixing element and of the connection element is generally simpler and more reliable as the connection element can only be moved back and forth between the two relevant positions.

It is particularly preferred when the stop element is formed as a locking element which protrudes in the axial direction and projects into an opening of the basic body.

This means that a second axial stop, which can be mounted simply by sliding the connection element onto the basic body, can be provided using simple means.

It is generally preferred when the connection element has at least one tappet element which connects the connection element to the connecting piece so as to be releasable in the axial direction.

This means that the disassembly of the connecting piece can be simplified as when pulling off or releasing the connecting piece, the tappet element moves the connection element out of the fitting position into the pre-assembly position.

In this case, it is particularly preferred when the connecting piece is releasable from the connection element by means of a predefined pulling force.

This means that when the pre-assembly position is reached, the connecting piece can be simply and reliably released from the connection element by increasing the pulling force.

In this case, it is particularly preferred when the tappet element is formed as a locking element.

This means that using simple means it is possible to realize a releasable connection which is releasable by means of a predefined pulling force.

It is obvious that the above-mentioned features and the features yet to be explained below can be used not only in the combination provided in each case, but also in other combinations or standing alone without departing from the framework of the present invention.

BRIEF DESCRIPTION OF THE SEVERAL VIEWS OF THE DRAWING

Exemplary embodiments of the invention are shown in the drawing and are explained in the following description, in which, in detail:

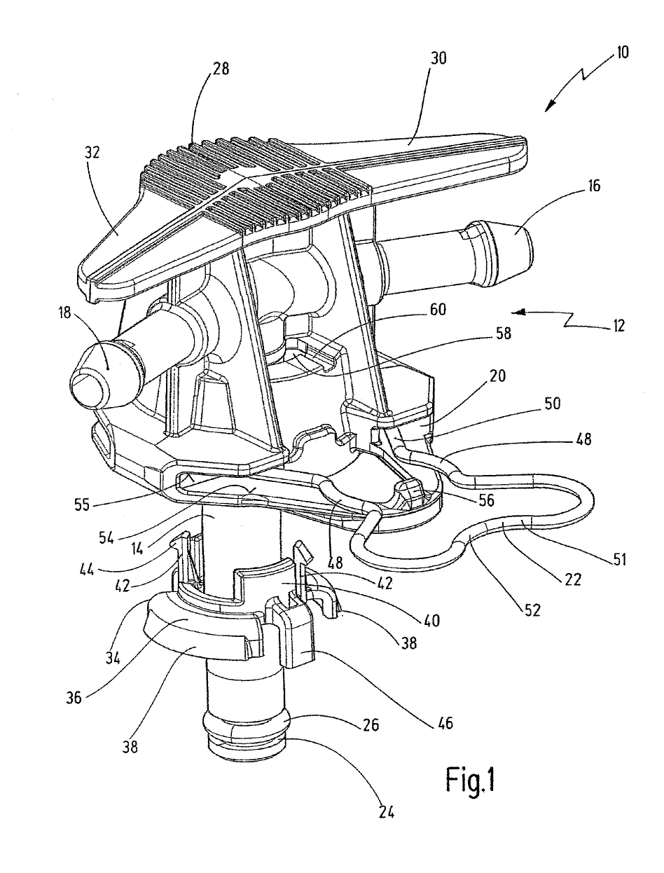

FIG. 1 shows a schematic perspective view of a plug-in connection arrangement with a connection element;

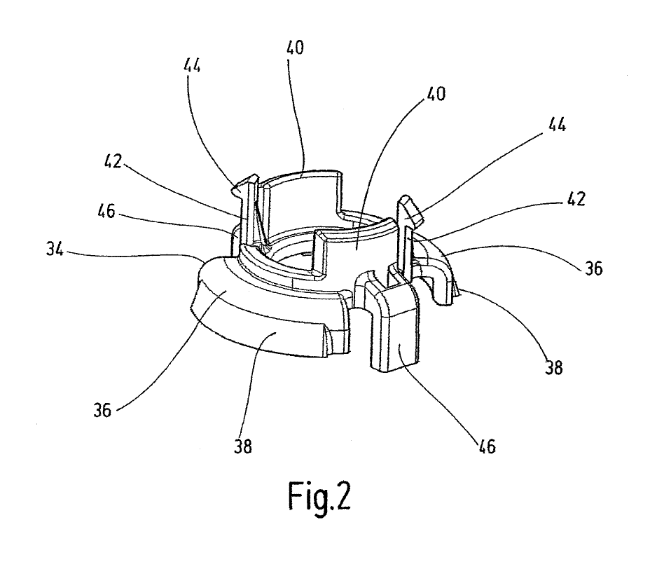

FIG. 2 shows a perspective detailed view of the connection element;

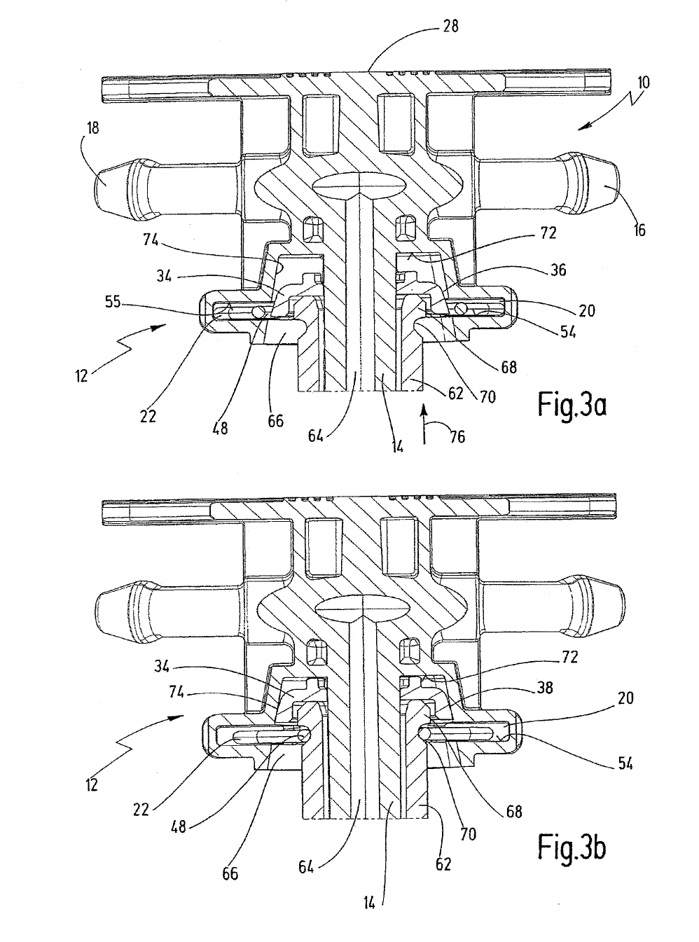

FIG. 3a, b show a schematic sectional view of the plug-in connection arrangement of FIG. 1 to explain the function of the connection element;

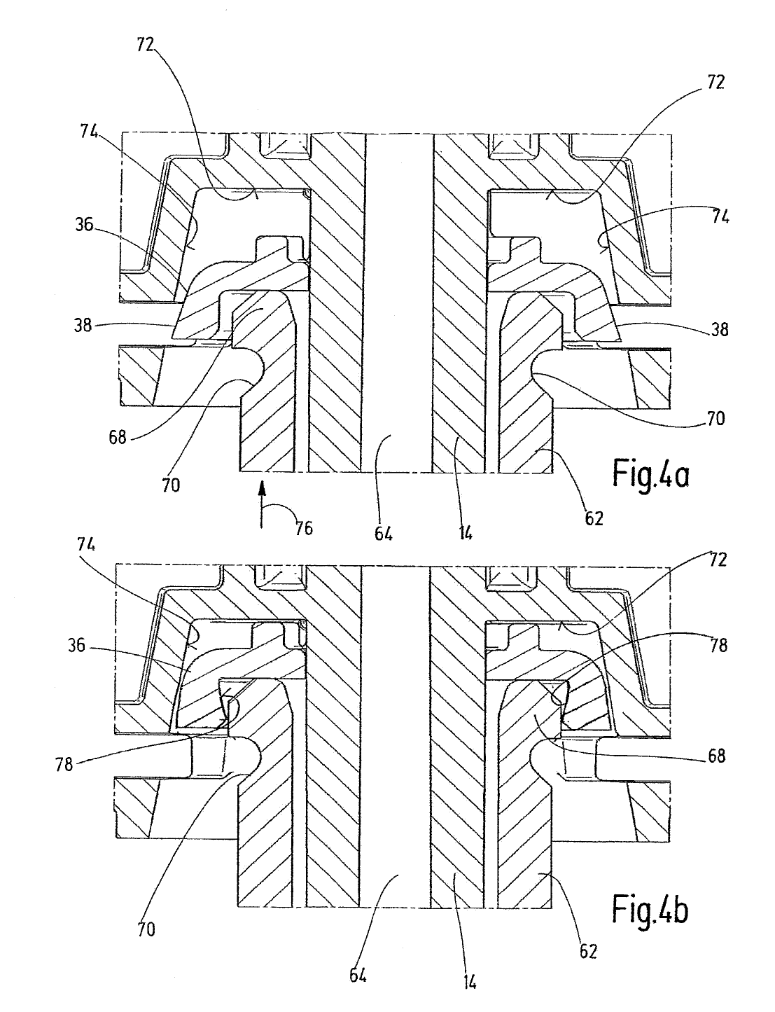

FIG. 4a, b show schematic sectional views of the plug-in connection arrangement of FIG. 1 to explain the centering function of the connection element;

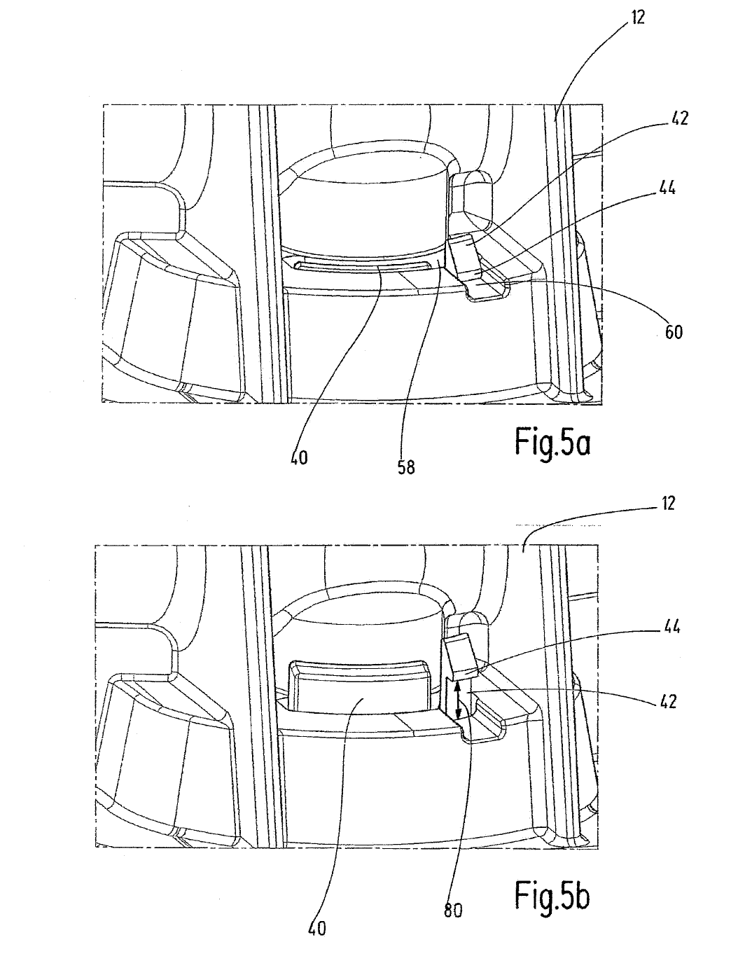

FIG. 5a, b show a schematic view of a portion of the basic body of the plug-in connection arrangement to explain a positional indicator and a stop element;

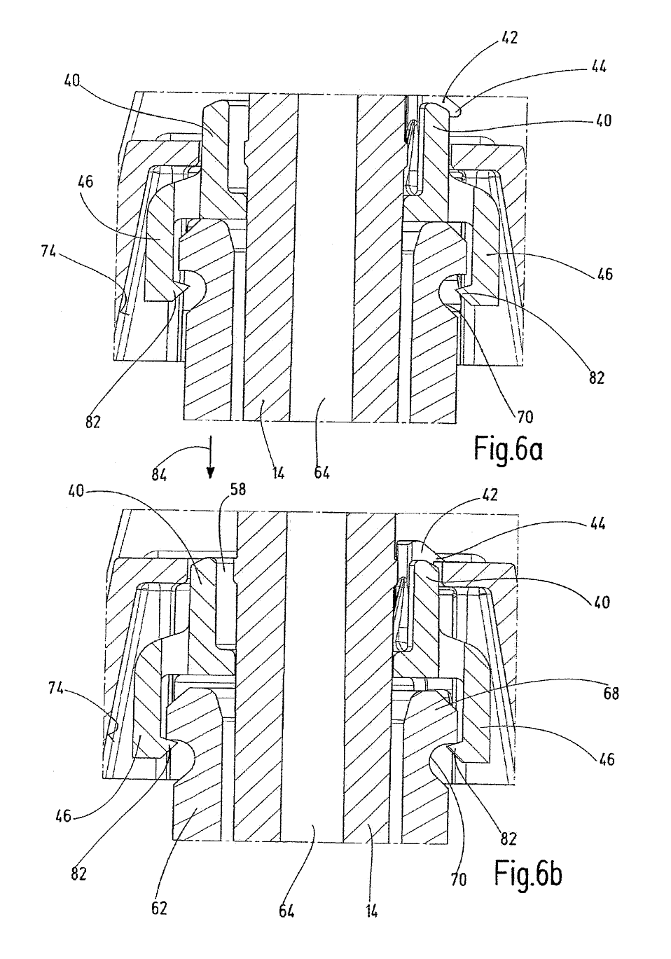

FIG. 6a, b show a schematic sectional view of the plug-in connection arrangement from FIG. 1 to explain a tappet element;

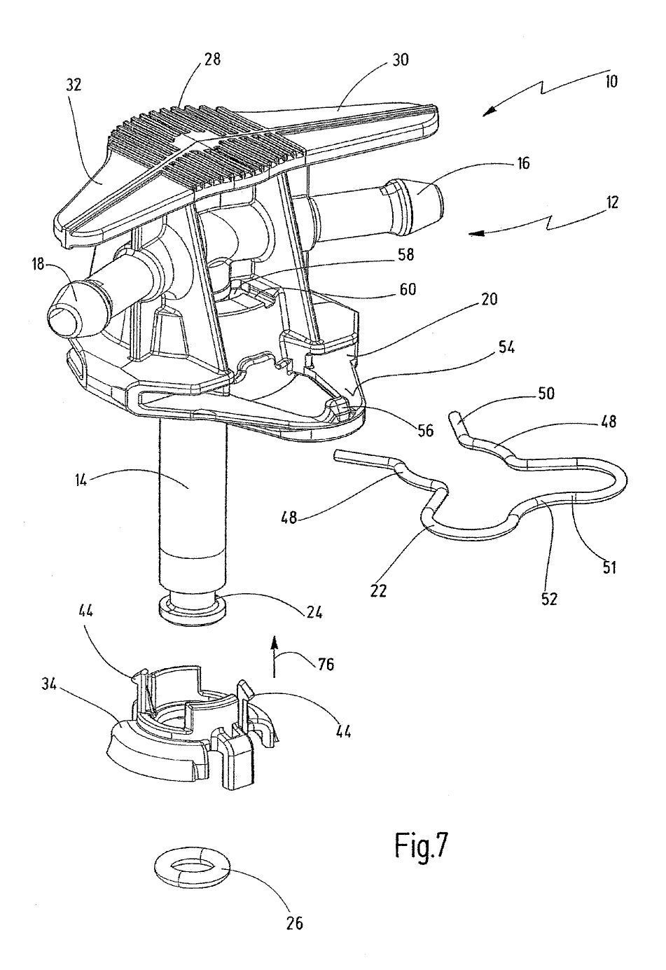

FIG. 7 shows an exploded perspective representation of the plug-in connection arrangement of FIG. 1;

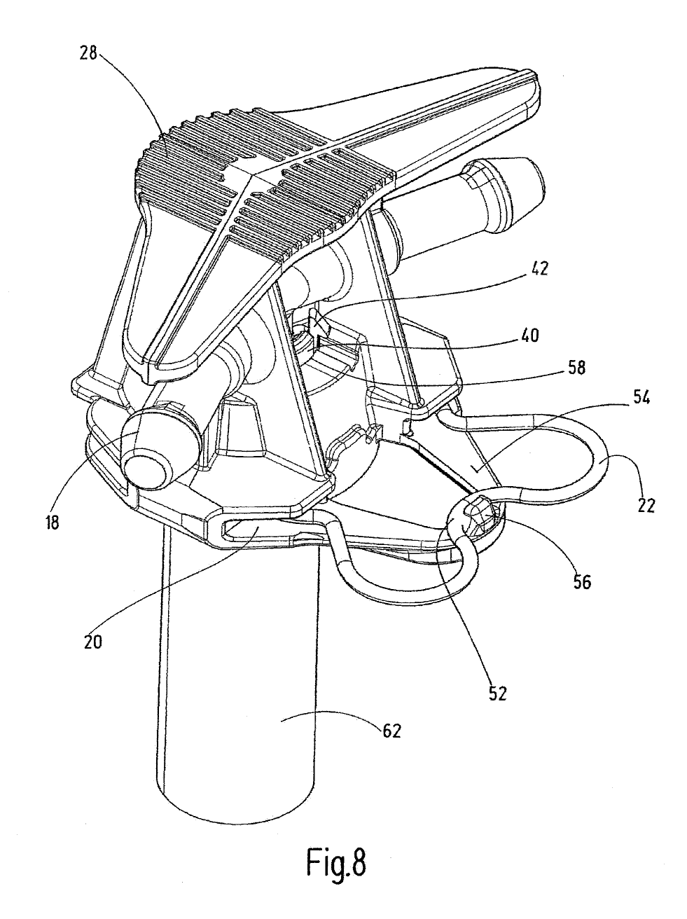

FIG. 8 shows a perspective representation of the plug-in connection arrangement with the connecting piece slid on; and

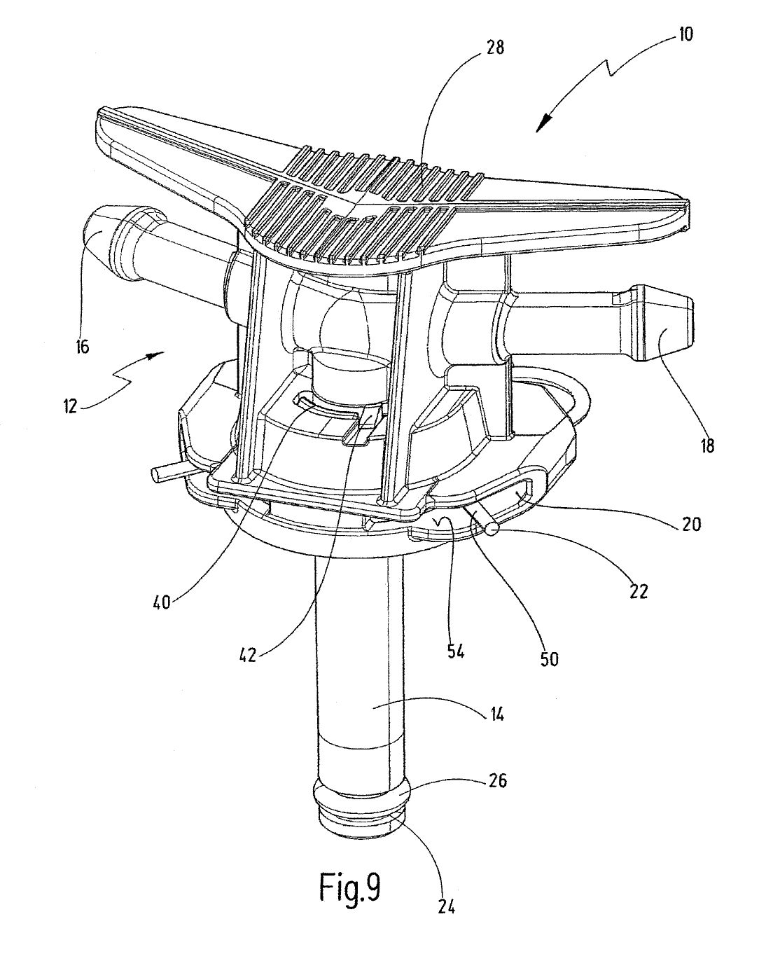

FIG. 9 shows a schematic perspective representation of a rear side view of the plug-in connection arrangement of FIG. 1.

### DETAILED DESCRIPTION OF THE INVENTION

A schematic representation of a plug-in connection arrangement is shown in FIG. 1 and is generally designated by 10.

The plug-in connection arrangement 10 has a basic body 12 with a supply line 14 and two connecting pieces 16, 18. A radial insertion opening 20 in which a fixing element 22 is accommodated is formed in the basic body 12. At a distal end, the supply line 14 has a circumferential groove 24, in which an O-ring seal 26 is accommodated. On a side opposite the supply line 14, the basic body 12 has an assembly portion 28 which is formed as a horizontal face perpendicular with respect to a longitudinal axis of the supply line 14. On its surface, the assembly portion 28 has a rib profile. Two wings 30, 32, which are formed in the same plane as the assembly portion 28, extend from the assembly portion 28. The wings 30, 32 are formed above the connecting pieces 16, 18 and cover the connecting pieces 16, 18 when the supply line 14 is viewed in an axial direction.

A connection element 34 is arranged on the supply line 14. The connection element 34 is mounted on the supply line 14 so as to be movable in the axial direction. The connection element 34 is formed in a substantially ring-shaped manner and has two contact portions 36, which form two circumferential portions of the connection element 34. A projection 38, which protrudes in the radial direction in relation to the respective contact portion 36, is formed in each case on the contact portions.

Two extensions 40, which extend in the axial direction, are formed on the connection element 34. The extensions 40 are formed as bent elements coaxially with respect to the supply line 14. In addition, the connection element 34 has two stop elements 42 which extend in the axial direction. The stop elements 42 protrude in the axial direction in relation to the contact portion 36. The stop elements 42 have in each case a catch 44 which extends in the radial direction in relation to the stop element 42.

In addition, the connection element 34 has two tappets 46 which extend in the axial direction. The tappets 46 extend in a direction which is opposite to the continuations 40 and the stop elements 42.

The fixing element 22 is realized as a resilient clamp which is formed open on one side. The clamp is preferably formed from a resilient material such as, for example, metal or plastics material. The fixing element 22 has two fixing portions 48 which are realized on two opposite sides and have a circular form at least in portions. In addition, the fixing element 22 has two insert portions 50 which connect to the fixing portions 48. The insert portions are formed in a substantially straight manner and together form a funnel form on the open side. The fixing element 22 also has a gripping portion 51 which is formed on one side of the fixing element 22 opposite the insert portions 50 or the open side. A stop portion 52, which forms a radial stop with an element of the basic body 12, is also realized on the fixing element 22 in the region of the gripping portion 51.

The radial insertion opening 20 is formed between a first guiding face 54 and a second guiding face 55, which are formed perpendicular with respect to a longitudinal axis of the supply line 14 and are located opposite one another. The fixing element 22 is accommodated between the guiding faces 54, 55 and is fixed in the axial direction. The guiding face 54 protrudes in the radial direction in relation to the guiding face 55 in order to make the insertion of the fixing element 22 easier. A stop element 56, against which the stop portion 52 of the fixing element strikes when being pulled out, is arranged on a radial end of the guiding face 54. This means that a captive situation is formed for the fixing element 22, as a result of which the fixing element can be prevented from being released completely when being pulled out of the insertion opening 20.

An opening 58, which extends in the axial direction of the supply line 14, is formed in the basic body 12 between the radial insertion opening 20 and the assembly portion 28. In addition, a stop 60 is formed in the region of the opening 58. The opening 58 is formed in an arcuate and coaxial manner with respect to the supply line 14. The opening 58 is formed such that the extensions 40 can project through the opening in order to indicate a fitting position of the connection element 34, as is explained in more detail below. The stop element 42 can also project through the opening 58 such that the catch 44 engages behind the stop 60 and consequently forms an axial stop for the connection element 34.

The plug-in connection arrangement 10 generally serves for the purpose of connecting fluid lines together. To this end, two fluid lines are connected to the connecting pieces 16, 18 and a further fluid line, which is connected to a connecting piece which is not shown in FIG. 1, is connected to the basic body 12 by the connecting piece being slipped onto the supply line 14 and being secured in a fitting position by means of the fixing element 22. In other words, the supply line 14 is inserted into the connecting piece which is not shown here and is secured by means of the fixing element 22.

Before the connecting piece is slipped onto the supply line 14, the connection element 34 is arranged in a pre-assembly position in the region of the radial insertion opening 20 and the fixing portions 48 of the fixing element 22 are moved to abut against the contact portions 36 and are radially prestressed. The connection element 34, pre-assembled in this manner, is then moved into a final assembly position as the connecting piece is slipped on and the prestressed fixing portions 48 abut against the connecting piece in order to fix said connecting piece in the end assembly position.

The connecting pieces 16, 18 are arranged in an angled manner with respect to one another. This is brought about by a particular fitting position of the plug-in connection arrangement 10 and enables hoses which are connected to the connecting pieces 16, 18, to be bent in a defined manner. In an advantageous manner, this means that the operating step in which the connecting hoses have to be bent in order to be connected to the connecting pieces 16, 18 is omitted when the plug-in connection arrangement 10 is mounted.

The fixing element 22 is fixed in the axial direction in the radial insertion opening 20 and is mounted so as to be movable in the radial direction. This means that the fixing element can fix the connecting piece in the axial direction and can be guided in and out in the radial direction.

FIG. 2 shows a perspective view of the connection element 34 in detail. The connection element 34 is ring-shaped and has the contact portions 36, against which the fixing portions 48 are moved to abut in the pre-assembly position. The contact portions 36 are formed in each case on an arcuate element which protrudes in an axial direction. A projection 38, which extends in each case in the radial direction in relation to the contact portion 36, is formed in each case on the contact portions 36, wherein a substantially conical face being formed in portions by the respective projection. The projections 38 serve for the purpose of fixing the connection element 34 in a fitting position in relation to the basic body 12 and of fixing and centering an axial end of the connecting piece to be connected, as is explained in more detail below.

The extensions 40 and the stop elements 42 extend in the axial direction. In a fitting position of the connection element 34, the extensions 40 protrude into the opening 58 and can consequently indicate the fitting position of the connection element 34. Furthermore, the stop elements 42 also protrude through the opening 58, and their catches 44 form with the stop 60 an axial stop for the connection element 34. In addition, the tappets 46, which extend in an axial direction opposite to the extensions 40 and the stop elements 42, are formed on the connection element 34. The tappets 46 in each case have an inwardly directed catch (not shown here) in order to form a releasable connection with a groove of the connecting piece, as is explained in more detail below.

The connection element 34 is formed separately from the basic body 12, separately from the connecting piece and separately from the fixing element 22.

FIG. 3a and b show schematic sectional views of the plug-in connection arrangement 10 to explain the method of operation of the plug-in connection arrangement 10. Identical elements are designated by identical reference numerals, only the characteristic features being explained here.

In FIG. 3a, a connecting piece 62 is slipped onto the supply line 14 coaxially with respect to the supply line 14. The supply line 14 has an inner fluid line 64 which is connected to inner lines of the connecting pieces 16, 18 and forms a tee joint. An opening 66, which surrounds the supply line 14, is formed in the basic body 12. The opening 66 is formed in the guiding face 54. The connection element 34 is shown in the pre-assembly position in FIG. 3a such that the fixing element 22 or the fixing portions 48 abut against the respective contact portions 36 of the connection element 34. In this position, the connection element 34 widens the fixing element 22 in the radial direction and prestresses the fixing portions 48 in the radial direction. As the fixing element 22 is secured between the guiding faces 54, 55 in the axial direction, the fixing portions 48 are only able to move in the radial direction.

The connecting piece 62 is inserted into the opening 66 such that an axial end of the connecting piece 62 abuts against the connection element 34. The connecting piece 62 has an end portion 68 which is formed at the axial end of the connecting piece 62. The connecting piece 62 also has a groove 70 which is realized, at least in portions, circumferential on the connecting piece 62. The groove 70 connects directly to the end portion 68 in the axial direction of the connecting piece 62. In the preassembly position shown in FIG. 3a, the end portion 68 is surrounded circumferential by the contact portions 36.

An axial stop 72 is also formed on the basic body 12. The axial stop 72 is formed as a face perpendicular with respect to a longitudinal axis of the supply line 14. An accommodation portion 74, which can be formed in a cylindrical or conical manner and into which the connection element 34 projects in part in the position shown in Fig, 3a, is additionally formed in the basic body 12.

The connecting piece 62 is basically slipped onto the supply line 14 in a slip-on direction, as is indicated by an arrow 76.

In FIG. 3b, an end position or a fitting position of the connection element 34 and of the connecting piece 62 is shown. Identical elements are designated with identical reference numerals, only the characteristic features being explained here.

When, proceeding from the pre-assembly position shown in FIG. 3a, the connecting piece 62 is pushed in further in the direction of the arrow 76, the contact portions 36 release the fixing portions 48 such that they move inward as a result of the radial prestressing and come to rest in the groove 70 of the connecting piece 62.

As the fixing element 22 is fixed between the guiding faces 54, 55 in the axial direction, the connecting piece 62 is also fixed in the axial direction in said fitting position. The connection element 34 is abutted against the axial stop 72 in the axial direction such that a defined axial position is achieved. In addition, the projections 38 abut against the accommodating portion 74 such that the connection element 34 is centered in a coaxial manner.

A tight connection is formed between the supply line 14 and the connecting piece 62 by means of the O-ring seal 26 in said fitting position such that the fluid lines are connected together in a tight manner.

By the connection element 34 already prestressing the fixing element 22 in the radial direction in the pre-assembly position, which is shown in FIG. 3a, and only a small force having to be exerted in the direction of the arrow 76 by means of the connecting piece 62 in order to move the connection element 34 into the end position or the fitting position, the time and money spent on assembly for plugging on and fixing the connecting piece 62 is clearly reduced. The connecting piece 62 is slipped on or the supply line 14 is inserted by means of a force which is exerted onto the assembly portion 28.

FIG. 4a, b show a schematic sectional view of the plug-in connection arrangement 10 to explain the centering of the connecting piece 62 by means of the connection element 34. Identical elements are designated with identical reference numerals, only the characteristic features being explained here.

FIG. 4a shows the connection element 34 in the pre-assembly position in which the connecting piece 62 has already been moved to abut against the connection element 34. The outer diameter of the projections 38 is larger than the inner diameter of the accommodating portion 74. In so far as the connecting piece 62 is pushed into the basic body 12 in the direction of the arrow 76, the connection element 34 abuts against the axial stop 72, the projections 38 being pressed inward in the radial direction at the same time.

FIG. 4b shows the fitting position of the connection element 34 and of the connecting piece 62. The projections 38 are pressed radially inward in said position, as a result of which an inner circumferential face 78 of the connection element 34 is moved to abut against the end portion 68 and fixes and centers the connecting piece 62 coaxially with respect to the supply line 14. This means that a particularly precise fitting position of the connecting piece is achieved by means of the connection element 34.

FIGS. 5a and b show schematic representations of views of details of the basic body 12 to explain the method of operation of the extensions 40 and of the stop element 42.

FIG. 5a shows the connection element 34 in the pre-assembly position shown in FIGS. 3a and 4a. The extension 40 does not project through the opening 58 in said pre-assembly position. The stop element 42 projects in part through the opening 58, far enough for the catch 44 to be able to engage just behind the stop 60 and consequently form an axial stop with the basic body 12. The catch 44 serves the purpose of not allowing the connection element 34 to be moved further away from the basic body 12 in so far as it has reached the pre-assembly position. In other words, the connection element 34 is secured in said pre-assembly position in so far as the fixing element 22 is fixed on the contact portions 36.

In so far as the connecting piece 62 is moved in the direction of the arrow 76 from FIGS. 3a and 4a, the connection element 34 is moved into the end position and the extension 40 is pushed right through the opening 58, as is shown in FIG. 5b. The stop element 42 is also moved upward right through the opening 58. In the position shown in FIG. 5b, the connection element 34 is moved to abut against the axial stop 72 such that the extension 40 and the stop element 42 are no longer able to be moved right through the opening 58. In said second axial position of the connection element 34, the end assembly position is achieved. An idle path 80, which is shown schematically in FIG. 5, is formed between the catch 44 and the axial stop 72.

Consequently, the final assembly position of the connection element 34 is indicated by means of the extension 40 using simple means such that the correct assembly of the connection element 34 and of the connecting piece 62 is able to be checked from the outside. The axial movement of the connection element 34 is restricted by the stop element 42, the axial stop 72 and the idle path 80 formed between said two stops such that the connection element 34 is only able to move between the pre-assembly position and the final assembly position.

FIG. 6a and b show schematic sectional views of the plug-in connection arrangement 10 to explain the method of operation of the tappets 46. Identical elements are designated with identical reference numerals, only the characteristic features being explained here.

Each of the tappets 46 has a locking element 82 which extends radially inward. In the fitting position of the connection element 34 shown in FIG. 6a, the locking elements 82 are arranged in the grooves 70 of the connecting piece 62. In so far as the connecting piece 62 is to be disassembled, the fixing element 22 is initially released and the connecting piece 62 is then pulled from the supply line 14 in the direction of an arrow 84. When the grooves 70 strike against the locking elements 82, the connection element 34 is moved out of the fitting position in the direction of the arrow 84 and is moved back into the pre-assembly position, as is shown in FIG. 6b. In said position, the extension 40 does not project right through the opening 58 such that the pre-assembly position can easily be seen from the outside. In addition, the stop element 42 is moved to abut against the stop 60 in said position. When disassembling the connecting piece 62, the connection element 34 can easily be moved back into the preassembly position by means of said entrainment means 46 and once again can be fixed there by the fixing element 22 in order to be moved into the fitting position once again when the connecting piece 62 is mounted.

In order to release the connecting piece 62 totally from the supply line 14, the pulling force has to be increased in the direction of the arrow 84 in the position shown in FIG. 6b such that the tappets 46 are pivoted radially outward and the locking elements 82 release the connecting piece 62. Consequently, the connecting piece 62 is able to be released from the supply line 14 by means of a predefined pulling force.

An exploded representation of the plug-in connection arrangement 10 is shown in perspective in FIG. 7. Identical elements are designated with identical reference numerals, only the characteristic features being explained here.

First of all, the fixing element 22 is inserted radially into the insertion opening 20 until the fixing portions 48 are arranged coaxially with respect to the longitudinal axis of the supply line 14. The connection element 34 is then slipped onto the supply line 14 in the axial direction of the arrow 76 until the catch 44 is guided right through the opening 58 and engages behind the stop 60. In said position, the fixing portions 48 have been moved radially outward and consequently prestressed in the radial direction. In said position, slipping on the connecting piece 62 is easily possible and by expending little force as the necessary prestressing of the fixing element 22 has already been effected by the connection element 34. The connection element 34 is fixed in said pre-assembly position by the radial pre-stressing of the fixing element 22 and by the axial stop which is formed by the catch 44 and the stop 60.

FIG. 8 shows the plug-in connection arrangement 10 in perspective with a mounted connecting piece 62. Identical elements are designated with identical reference numerals, only the characteristic features being explained here.

By means of the extensions 40 and the stop element 42, which clearly project through the opening 58, it can be seen that the connection element 34 is situated in the fitting position. The connecting piece 62 has been completely slipped onto the supply line 14, the fixing element 22 already being situated in a disassembly position. In said position, the stop portion 52 is moved to abut against the stop 56 such that in said disassembly position the connecting piece 62 can already be pulled down in the axial direction from the supply line 14. This means that a non-destructive, simple disassembly of the connecting piece 62 is possible.

FIG. 9 shows a schematic representation in perspective of a rear side view of the plug-in connection arrangement 10. Identical elements are designated with identical reference numerals, only the characteristic features being explained here

In this position, the extensions 40 and the stop element 42 indicate that the connection element 34 is situated in the pre-assembly position. The insert portions 50 of the fixing element 22 are inserted completely into the radial insertion opening such that they project out of the radial insertion opening again on the opposite side. In said position, consequently, the connection element 34 is fixed in the preassembly position by means of the fixing portions 48 such that the plug-in connection arrangement 10, provided in such a manner, is ready for assembly with the connecting piece 62.

It is obvious that the plug-in connection arrangement 10 can also have just one of the connecting pieces 16, 18, or, however, more than two of the connecting pieces 16, 18.

The plug-in connection arrangement 10 is preferably used as an overflow oil line in order to return surplus fuel from a combustion engine back into the fuel tank in order to supply it to the combustion engine again.

What is claimed is:

1. A plug-in connection arrangement for releasably connecting fluid lines, said plug-in connection arrangement comprising:
a basic body which has a supply line and a insertion opening, wherein the basic body is connectable to one of the fluid lines, and wherein a connecting piece, which is formed as a connection tube is connectable to a second of the fluid lines, can be plugged onto the supply line in order to form a tight connection with the supply line,
a fixing element which is accommodated in the insertion opening and is fixed in the insertion opening in the axial direction of the supply line in order to secure the connecting piece in a fitting position, and
a connection element which is mounted on the supply line so as to be movable in the axial direction between a first and a second axial position,
wherein the fixing element abuts against the connection element in the first axial position and wherein the connection element prestresses the fixing element in the radial direction in the first axial position, and wherein the connection element is movable into a second axial position by means of the connecting piece such that the fixing element is released from the connection element, and abuts against the connecting piece in order to secure the connecting piece in the axial direction in the fitting position.

2. A plug-in connection arrangement for releasably connecting fluid lines, said plug-in connection arrangement comprising:
a basic body which has a supply line and a insertion opening, wherein the basic body is connectable to one of the fluid lines, and wherein a connecting piece, which is connectable to a second of the fluid lines, can be plugged onto the supply line in order to form a tight connection with the supply line,
a fixing element which is accommodated in the insertion opening and is fixed in the insertion opening in the axial direction of the supply line in order to secure the connecting piece in a fitting position, and
a connection element which is mounted on the supply line so as to be movable in the axial direction and prestresses the fixing element in the radial direction in an axial position.

3. The plug-in connection arrangement as claimed in claim 2, wherein the connection element is movable into a second axial position by means of the connecting piece such that the fixing element abuts against the connecting piece and secures the connecting piece in the axial direction.

4. The plug-in connection arrangement as claimed in claim 3, wherein the basic body has an axial stop for the connecting piece, and wherein the connecting element in the second axial position is arranged between the axial stop and the insertion opening.

5. The plug-in connection arrangement as claimed in claim 2, wherein the basic body has an accommodating portion which is formed between an axial stop of the basic body and the insertion opening, wherein a connection element is insertable into the accommodating portion by means of the connecting piece, and wherein the connection element in the accommodating portion is compressed in such a manner that the connecting piece is fixed coaxially with respect to the supply line.

6. The plug-in connection arrangement as claimed in claim 5, wherein the connection element has a centering portion with an outer radius which is greater than an inner radius of the accommodating portion.

7. The plug-in connection arrangement as claimed in claim 5, wherein the accommodating portion is formed coaxially with respect to the supply line.

8. The plug-in connection arrangement as claimed in claim 2, further comprising a connection element which is mounted on the supply line so as to be movable in the axial direction, wherein the connection element is movable into a fitting position by means of the connecting piece, wherein the connection element has an extension which protrudes in the axial direction and projects into an opening of the basic body in the fitting position in order to indicate the position of the connection element.

9. The plug-in connection arrangement as claimed in claim 8, wherein the connection element is arranged between an axial stop of the basic body and the insertion opening in the fitting position.

10. The plug-in connection arrangement as claimed in claim 2, wherein the connection element has a stop element which forms a second axial stop for the connection element with the basic body and wherein an idle path is formed between the first axial stop and the second axial stop.

11. The plug-in connection arrangement as claimed in claim 10, wherein the connection element is mounted on the supply line between the first and the second axial stop so as to be movable in the axial direction

12. The plug-in connection arrangement as claimed in claim 10, wherein a fitting position of the connection element is formed at the first axial stop and a preassembly position is formed at the second axial stop.

13. The plug-in connection arrangement as claimed in claim 10, wherein the stop element is formed as a locking element which protrudes in the axial direction and projects into an opening of the basic body.

14. The plug-in connection arrangement as claimed in claim 2, wherein the connection element has at least one tappet element which connects the connection element to the connecting piece in the axial direction so as to be releasable.

15. The plug-in connection arrangement as claimed in claim 14, wherein the tappet element is formed in such a manner that the connecting piece is releasable from the connection element by means of a predefined pulling force.

16. The plug-in connection arrangement as claimed in claim 14, wherein the tappet element is formed as a locking element.

17. A plug-in connection arrangement for releasably connecting fluid lines, said plug-in connection arrangement comprising:
a basic body which has a supply line and a insertion opening, wherein the basic body is connectable to one of the fluid lines, and wherein a connecting piece, which is connectable to a second of the fluid lines, can be plugged onto the supply line in order to form a tight connection with the supply line,
a fixing element which is accommodated in the insertion opening and is fixed in the insertion opening in the axial direction of the supply line in order to secure the connecting piece in a fitting position,
wherein the basic body has an accommodating portion which is formed between an axial stop of the basic body and the insertion opening, wherein a connection element is insertable into the accommodating portion by means of the connecting piece, and wherein the connection element in the accommodating portion is compressed in such a manner that the connecting piece is fixed coaxially with respect to the supply line.

18. The plug-in connection arrangement as claimed in claim 17, wherein the connection element has a centering portion with an outer radius which is greater than an inner radius of the accommodating portion.

19. A plug-in connection arrangement for releasably connecting fluid lines, said plug-in connection arrangement comprising:
a basic body which has a supply line and a insertion opening, wherein the basic body is connectable to one of the fluid lines, and wherein a connecting piece, which is connectable to a second of the fluid lines, can be plugged onto the supply line in order to form a tight connection with the supply line,
a fixing element which is accommodated in the insertion opening and is fixed in the insertion opening in the axial direction of the supply line in order to secure the connecting piece in a fitting position, and
a connection element which is mounted on the supply line so as to be movable in the axial direction, wherein the connection element is movable into a fitting position by means of the connecting piece, wherein the connection element has an extension which protrudes in the axial direction and projects into an opening of the basic body in the fitting position in order to indicate the position of the connection element.

20. The plug-in connection arrangement as claimed in claim 19, wherein the connection element has a stop element which forms a second axial stop for the connection element with the basic body and wherein an idle path is formed between the first axial stop and the second axial stop.

21. The plug-in connection arrangement as claimed in claim 20, wherein a fitting position of the connection element is formed at the first axial stop and a preassembly position is formed at the second axial stop.

22. The plug-in connection arrangement as claimed in claim 19, wherein the connection element has at least one tappet element which connects the connection element to the connecting piece in the axial direction so as to be releasable.
